(19) United States
(12) Patent Application Publication
(10) Pub. No.: US 2021/0149483 A1
(43) Pub. Date: May 20, 2021

(54) SELECTIVE IMAGE CAPTURE BASED ON MULTI-MODAL SENSOR INPUT

(71) Applicant: Bose Corporation, Framingham, MA (US)

(72) Inventors: William Berardi, Grafton, MA (US); Nathan A. Blagrove, Wayland, MA (US); Craig Desrosiers, Attleboro Falls, MA (US); Paul Franzosa, Arlington, MA (US); Francois Laberge, Wellesley, MA (US); Naganagouda B. Patil, Ashland, MA (US)

(73) Assignee: Bose Corporation, Framingham, MA (US)

(21) Appl. No.: 16/686,403

(22) Filed: Nov. 18, 2019

(51) Int. Cl. G06F 3/01; H04R 1/32; G02B 27/00; G06F 3/16

(52) U.S. Cl. CPC G06F 3/013; H04R 1/32; G01S 17/023; G06F 3/167; G02B 27/0093

(57) ABSTRACT

Methods and systems for selective image capture based on multi-modal sensor input for a wearable device. Systems comprise a first sensor, a second sensor, and a wearable device. The first sensor is configured to capture a first image, and the second sensor is configured to collect motion data, the motion data corresponding to a relative motion between the user and the wearable device, the relative motion of the wearable device in the environment, or the motion of a body part of the user. The wearable device comprises: a communication module configured to wirelessly transmit the first image to a receiving device; and a processor configured to detect a trigger event based on the motion data collected by the second sensor, the processor further configured to initiate capture of the first image by the first sensor or transmit the first image to the receiving device by the communication module upon detection of the trigger event.

### BACKGROUND

The present disclosure generally relates to methods and systems for a wearable device involving selective image capture based multi-modal sensor input.

### SUMMARY

All examples and features mentioned below can be combined in any technically possible way.

Generally, in one aspect, a wearable device is provided. The wearable device comprises: a first sensor configured to capture a first image; a second sensor configured to collect motion data, the motion data corresponding to a relative motion between a user and the wearable device, the relative motion of the wearable device in an environment, or a motion of a body part of the user; a communication module configured to wirelessly transmit the first image to a receiving device; and a processor configured to detect a trigger event based on the motion data collected by the second sensor, the processor further configured to initiate capture of the first image by the first sensor or initiate transmission of the first image to the receiving device by the communication module upon detection of the trigger event.

In an aspect, the first sensor is a visual camera, thermal imaging sensor, or Light Detection and Ranging (LiDAR) sensor.

In an aspect, the second sensor is an inertial measurement unit (IMU) comprising one or more accelerometers, one or more gyroscopes, or one or more magnetometers.

In an aspect, the second sensor is an eye movement sensor or a location sensor.

In an aspect, the trigger event corresponds with a detection that the wearable device has come to rest for a minimum duration after a period of motion.

In an aspect, the trigger event corresponds with a fixation of a gaze of the user in a first direction for a period of time.

In an aspect, the trigger event corresponds with recognition that the wearable device is in a first location or has changed location.

Generally, in one aspect, a system for selective image capture is provided. The system comprises: a first sensor configured to capture a first image; and a wearable device. The wearable device comprises: a second sensor configured to collect motion data, the motion data corresponding to a relative motion between a user and the wearable device, the relative motion of the wearable device in an environment, or a motion of a body part of the user; a communication module configured to wirelessly transmit the first image to a receiving device; and a processor configured to detect a trigger event based on the motion data collected by the second sensor, the processor further configured to initiate capture of the first image by the first sensor or initiate transmission of the first image to the receiving device by the communication module upon detection of the trigger event.

In an aspect, the first sensor is a visual camera, thermal imaging sensor, or Light Detection and Ranging (LiDAR) sensor.

In an aspect, the first sensor is arranged on a peripheral device and a field of view of the first sensor is controllable by the wearable device.

In an aspect, the second sensor is an inertial measurement unit (IMU) comprising one or more accelerometers, one or more gyroscopes, or one or more magnetometers.

In an aspect, the second sensor is an eye movement sensor or a location sensor.

In an aspect, the trigger event corresponds with a detection that the wearable device has come to rest for a minimum duration after a period of motion or the trigger event corresponds with a fixation of a gaze of the user in a particular direction for a period of time.

In an aspect, the trigger event corresponds with a recognition that the wearable device is in a first location or has changed location.

Generally, in one aspect, a method for selective image transmission is provided. The method comprises: capturing a first image using a first sensor; detecting a trigger event using a second sensor configured to collect motion data, the motion data corresponding to a relative motion between a user and a wearable device, the relative motion of the wearable device in an environment, or a motion of a body part of the user, and a processor of the wearable device, the processor configured to detect a trigger event based on the motion data collected by the second sensor; storing the first image on a memory of the wearable device; and transmitting the first image to a receiving device using a communication module of the wearable device, the communication module arranged to wirelessly transmit the first image to the receiving device.

In an aspect, the first sensor is a visual camera, thermal imaging sensor, or Light Detection and Ranging (LiDAR) sensor.

In an aspect, the second sensor is an inertial measurement unit (IMU) comprising one or more accelerometers, one or more gyroscopes, or one or more magnetometers.

In an aspect, the second sensor is an eye movement sensor or a location sensor.

In an aspect, the trigger event corresponds with a detection that the wearable device has come to rest for a minimum duration after a period of motion or the trigger event corresponds with a fixation of a gaze of the user in a particular direction for a period of time.

In an aspect, the trigger event corresponds with recognition that the wearable device is in a first location or has changed location.

Generally, in one aspect, a system for selective image capture is provided. The system comprises: a first sensor configured to capture a first image; a second sensor configured to collect motion data, the motion data corresponding to a relative motion between the user and the wearable device, the relative motion of the wearable device in the environment, or motion of a body part of a user; and a wearable device. The wearable device comprises: a communication module configured to wirelessly transmit the first image to a receiving device; and a processor configured to detect a trigger event based on the motion data collected by the second sensor, the processor further configured to initiate capture of the first image by the first sensor or initiate transmission of the first image to the receiving device by the communication module upon detection of the trigger event.

In an aspect, the second sensor is a capacitive touch sensor.

In an aspect, the second sensor is a visual sensor.

In an aspect, the second sensor is a motion sensor.

In an aspect, the second sensor is arranged apart from the wearable device.

In an aspect, the trigger event corresponds with detection of a gesture, a single-tap, a double-tap, a triple-tap, or a swipe.

In an aspect, the trigger event corresponds with detection of a hand wave, thumbs up, or a finger pinch.

Generally, in one aspect, a system for selective image capture is provided. The system comprises: a first sensor configured to capture a first image; and a wearable device. The wearable device comprises: a second sensor configured to collect sound data, the sound data corresponding to voice commands to trigger capture or transmission of the first image; a communication module configured to wirelessly transmit the first image to a receiving device; and a processor configured to detect a trigger event based on the sound data collected by the second sensor, the processor further configured to initiate capture of the first image by the first sensor or initiate transmission of the first image to the receiving device by the communication module upon detection of the trigger event.

In an aspect, the second sensor is a microphone.

In an aspect, the system further comprises a third sensor that is a visual sensor or a motion sensor.

In an aspect, the third sensor is arranged apart from the wearable device.

In an aspect, the system further comprises a database of voice commands.

Generally, in one aspect, a system for selective image capture is provided. The system comprises: a first sensor configured to capture a first image; a second sensor configured to capture a second low-resolution image; and a wearable device. The wearable device comprises: a communication module configured to wirelessly transmit the first image to a receiving device; and a processor configured to process image data from the second low-resolution image to detect a trigger event, the processor further configured to initiate capture of the first image by the first sensor or initiate transmission of the first image to the receiving device by the communication module upon detection of the trigger event.

In an aspect, the second low-resolution image is captured by a low resolution camera or a camera operating in a low-power state or a low-resolution state

In an aspect, the trigger event corresponds with a detection of an object in the second low-resolution image.

In an aspect, the trigger event corresponds with a detection of a motion artifact in the second low-resolution image.

Generally, in one aspect, a system for selective image capture is provided. The system comprises: a first sensor configured to capture a first image when operating in a high-resolution state and a second low-resolution image when operating in a low-resolution state; and a wearable device. The wearable device comprises: a communication module configured to wirelessly transmit the first image to a receiving device; and a processor configured to process image data from the second low-resolution image to detect a trigger event, the processor further configured to transition the first sensor from a low-resolution state to a high-resolution state and initiate capture of the first image by the first sensor or initiate transmission of the first image to the receiving device by the communication module upon detection of the trigger event.

In an aspect, the trigger event is the detection of an object in the second low-resolution image.

In an aspect, the trigger event is a detection of a motion artifact in the second low-resolution image.

In an aspect, settings of one or more cameras are adjusted to optimize for low power consumption based on a detection of a trigger event.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the various implementations.

FIG. 1 is a schematic illustration of a system for selective image capture according to aspects of the present disclosure.

FIG. 2 is a schematic illustration of a system for selective image capture according to aspects of the present disclosure.

FIG. 3 is a schematic illustration of components of a wearable device according to aspects of the present disclosure.

FIG. 4 is a schematic illustration of components of a receiving device according to aspects of the present disclosure.

FIG. 5 is a schematic illustration of components of a peripheral device according to aspects of the present disclosure.

FIG. 6 is a schematic illustration of components of a peripheral device according to aspects of the present disclosure.

FIG. 7 is a schematic illustration of components of a peripheral device according aspects of the present disclosure.

FIG. 8 is a flowchart showing steps in an exemplary method for selective image capture according aspects of the present disclosure.

### DETAILED DESCRIPTION

Wearable devices, particularly those that are head-worn, often have power constraints that limit computation, data communication, and sensor capability. Additionally, communication bandwidths are limited, which makes it difficult to transmit continuous streams of data (e.g. video) for processing by external devices. The present disclosure provides systems and methods that allow for more efficient use of system resources by making intelligent decisions about when to acquire and transmit images. Although the present disclosure describes the acquisition and transmission of images based on the detection of a trigger event, it should be appreciated that the methods, devices, and systems described herein can also be applied to the acquisition and/or transmission of other power and/or bandwidth intensive sensor data.

A wearable device may include aviation, military, or automotive headsets, over-the-ear headphones, audio eyeglasses or frames, military eyeglasses, a helmet, a hat, in-ear headphones or earbuds, around-ear devices, on-neck devices, open-ear audio devices (e.g., a wearable audio device that includes an acoustic driver to radiate acoustic energy towards the ear while leaving the ear open to its environment and surroundings), or other wearable devices such as smart watches, fitness trackers, headbands or the like. In some aspects, a wearable device is configured to be worn in or on at least a portion of a user's head and/or on at least a portion of a user's neck. In some aspects, a wearable device is configured to be positioned in, over, around, or on a user's body, attached to the user's body, or connected to another device positioned in, over, around, or on a user's body.

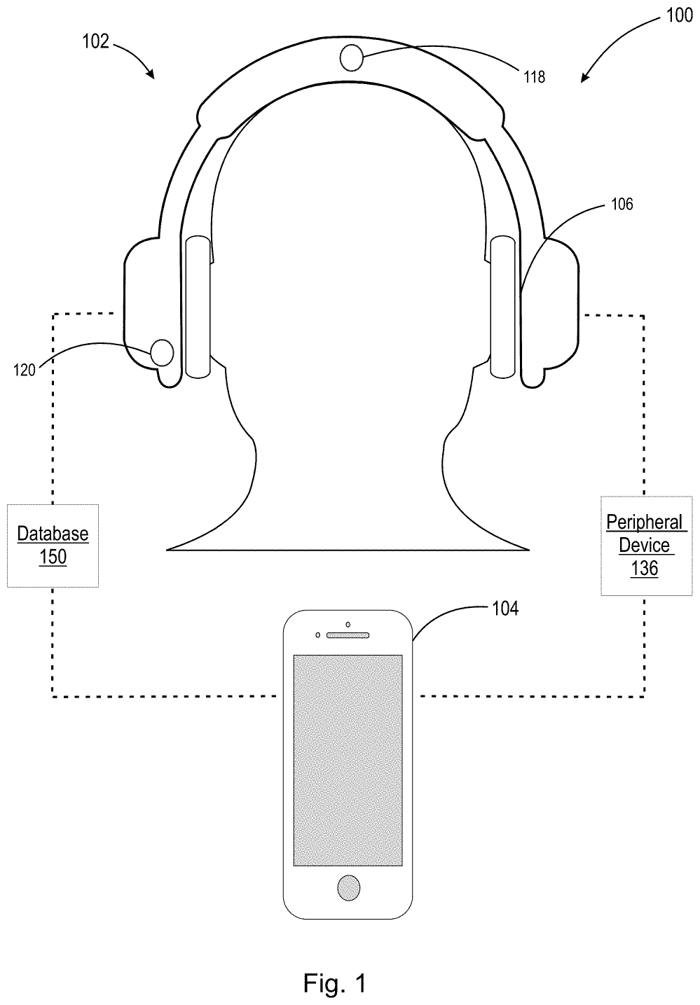

For example, the wearable device may be a headphone which fits around, on, in, or near an ear and that radiates acoustic energy into or towards the ear canal. Headphones are sometimes referred to as earphones, earpieces, headsets, earbuds or sport headphones, and can be wired or wireless. A headphone includes an acoustic driver to transduce audio signals to acoustic energy. A headphone may be connected mechanically to another headphone, for example by a headband and/or by leads that conduct audio signals to an acoustic driver in the headphone. A headphone may include components for wirelessly receiving audio signals. A headphone may include components of an active noise reduction system. Headphones may also include other functionality such as a microphone so that they can function as a headset. In some examples, a headphone may be an open-ear device that includes an acoustic driver to radiate acoustic energy towards the ear canal while leaving the ear open to its environment and surroundings. Although illustrated in FIG. 1 as over-ear headphones, it should be appreciated that wearable device 102 can be any type of headphone or wearable device capable of establishing a wireless data connection with receiving device 104.

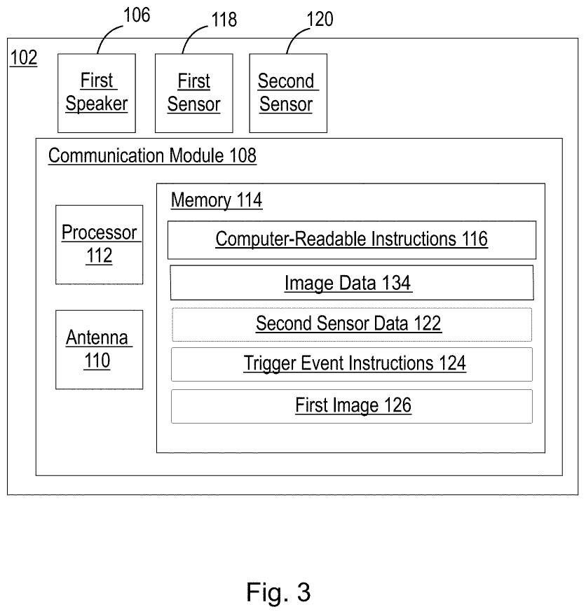

FIG. 1 is a schematic illustration of audio system 100 according to the present disclosure. System 100 includes a wearable device 102 and a receiving device 104 discussed below. Wearable device 102 includes first speaker 106 and communication module 108 (shown in FIG. 3). First speaker 106 is arranged to produce a first audio signal proximate at least one ear of a user in response to audio data sent and/or received from first communication module 108. Communication module 108 is arranged to send and/or receive data from an antenna, e.g., antenna 110 as shown in FIG. 3. The data sent or received can be, for example, audio data or communication data sent and/or received from at least one of a plurality of external devices (e.g., receiving device 104), data sent and/or received regarding a trigger event (discussed below), and data sent and/or received comprising first image data 134 (discussed below). It should be appreciated that communication module 108 can be operatively connected to processor 112 (shown in FIG. 3) and memory 114 (shown in FIG. 3). The processor 112 is arranged to detect a trigger event and instruct the first sensor 118 to capture a first image 126 or transmit the first image 126 to a receiving device 104. Memory 114 is arranged to store the first image 126 and instructions for the detection of a trigger event 124. The processor 112 and the memory 114 are operatively arranged to execute and store, respectively, a set of non-transitory computer-readable instructions 116 (shown in FIG. 3). It should also be appreciated that, although not illustrated, wearable device 102 may include a battery or other power source capable of providing electrical power to the various electronic components discussed above.

The wearable device 102 includes a first sensor 118 arranged on or within wearable device 102. First sensor 118 is arranged to capture a first image 126, where the first image 126 can be captured as part of an augmented reality experience or can include an image generated from data from a LIDAR sensor, radar sensor, thermal sensor, or ultrasonic sensor. First sensor 118 can be selected from: a LIDAR sensor, a radar sensor, a thermal sensor, an ultrasonic sensor, and/or a camera. Wearable device 102 includes a second sensor 120 (shown in FIG. 1 and FIG. 3) arranged on or within wearable device 102. Second sensor 120 is arranged to capture data corresponding with detection of a trigger event. It should be appreciated that first sensor 118 and/or the second sensor 120 may each comprise multiple sensors which together capture the first image 126 and first image data 134 and/or the second sensor data 122 which provides indication of a trigger event.

During operation of the wearable device 102, the second sensor 120 may collect motion data 122 corresponding to a relative motion between a user and the wearable device 102, the relative motion of the wearable device 102 in the environment, or motion of a body part of a user. The processor 112 may detect a trigger event based on data 122, for example, motion data, collected by the second sensor 120. The processor 112 may then send instructions, trigger event instruction 124, to the first sensor 118 to capture a first image 126. Alternatively, when the processor 112 detects a trigger event based on the data 122 collected by the second sensor 120, the trigger event instructions 124 instruct the processor 112 to initiate transmission of the first image 126 from the wearable device 102 to a receiving device 104 using the communication module 108 of the wearable device 102 and a communication module 128 of the receiving device 104. In some aspects, the first sensor 118 may have already captured the first image 126 before the second sensor 120 and processor 112 detect the trigger event, the first sensor 118 may capture the first image 126 after the second sensor 120 and processor 112 detect the trigger event, or the first sensor 118 may capture the first image 126 after being triggered by the processor 112 after the processor 112 detects the trigger event based on the data 122 collected by the second sensor 120. As an example, if the first image 126 is not transmitted to the receiving device 104, or before the first image 126 is transmitted to the receiving device 104, the first image 126 may be stored on the memory 114 of the wearable device 104.

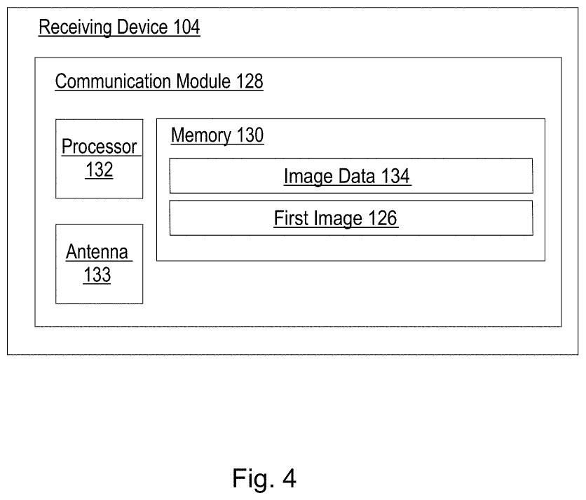

The receiving device 104 may be any device having a memory 130, processor 132, antenna 133, and communication module 128 (shown in FIG. 4), arranged to send and/or receive data, and receive image data 134 corresponding to the first image 126. The receiving device 104 may be a smartphone, tablet, or computer wirelessly connected to the wearable device 102. In one example, the receiving device 104 may be a server or other suitable database accessible via the cloud or the internet. In one example, the first image 126 is transmitted using a wireless connection established between the communication module 108 of the wearable device 102 and the communication module 128 of the receiving device 104 using a wireless protocol selected from: a Bluetooth protocol, a Bluetooth Low-Energy (BLE) protocol, a ZigBee protocol, Near-Field Magnetic Induction (NFMI), Near-Field Electromagnetic Induction (NFEMI), a Wi-Fi (IEEE 802.11) protocol, a radio frequency (RF) protocol, an ultra wide band protocol or any other protocol for establishing a wireless connection between wearable device 102 and the receiving device 104, or the wearable device 102 may connect with the receiving device 104 using 3G, 4G, or 5G mobile wireless telecommunications technology.

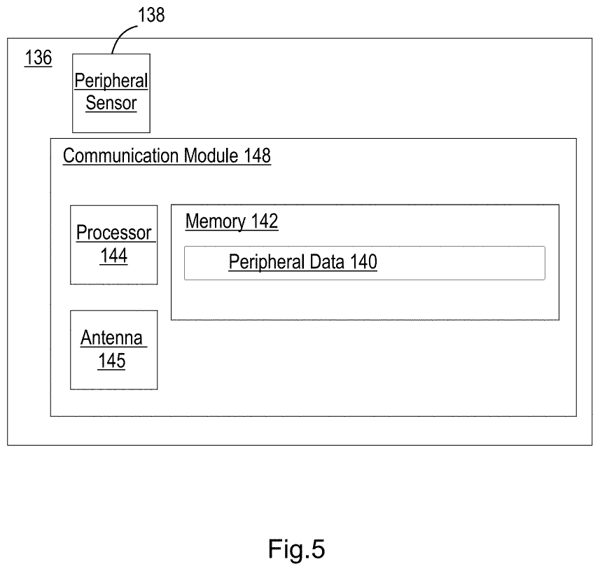

In another aspect, system 100 includes a wearable device 102, a receiving device 104, and a peripheral device 136 discussed below. The wearable device 102 includes a first sensor 118 (shown in FIG. 1 and FIG. 3) arranged on or within wearable device 102. First sensor 118 is arranged to capture a first image 126. Wearable device 102 includes a second sensor 120 (shown in FIGS. 1 and 3) arranged on or within wearable device 102. Second sensor 120 is arranged to capture data 122 corresponding with detection of a trigger event. The peripheral device 136 includes a peripheral sensor 138 which is arranged to obtain peripheral data 140 which can be used in conjunction with the data obtained by the second sensor 120 to detect a trigger event. The peripheral device 136 can be any device, having a memory 142, processor 144, and communication module 148 (shown in FIG. 5) capable of wireless communication with the wearable device 102.

During operation of the wearable device 102, the second sensor 120 may collect motion data 122 corresponding to a trigger event, for example, relative motion between a user and the wearable device 102 or the relative motion of the wearable device 102 in the environment. The peripheral device 136 may collect additional data 140 regarding the trigger event using the peripheral sensor 138 and may send the additional data 140 to the wearable device 102 using the communication module 148 of the peripheral device 136. The processor 112 of the wearable device 102 can then detect a trigger event based on the data 122 collected by the second sensor 120 and the data 140 collected by the peripheral device 136. For example, the second sensor 120 could be a microphone which is turned on to detect a voice command to capture the first image 126 once a peripheral sensor 138 on a peripheral device 140, for example, a camera facing the user, detect that the user's jaw is moving.

The processor 112 of the wearable device can then send a signal 124 to the first sensor 118 to capture a first image 126. Alternatively, when the processor 112 detects a trigger event based on the data 122 collected by the second sensor 120, the trigger event instructions 124 instruct the processor 112 to initiate transmission of the first image 126 from the wearable device 102 to a receiving device 104 using the communication module 108 of the wearable device 102 and a communication module 102 of the receiving device 104. The first sensor 118 may have already captured the first image 126 before the second sensor 120 and processor 112 detect the trigger event, the first sensor 118 may capture the first image 126 after the second sensor 120 and processor 112 detect the trigger event, or the first sensor 118 may capture the first image 126 after being triggered by the processor 112 after the processor 112 detects the trigger event based on the data 122 collected by the second sensor 120. As an example, if the first image 126 is not transmitted to the receiving device 104, or before the first image 126 is transmitted to the receiving device 104, the first image 126 may be stored on the memory 114 of the wearable device 104.

The receiving device 104 may be any device having a memory 130, processor 132, antenna 133, and communication module 128 (shown in FIG. 4), arranged to send and/or receive data, and receive image data 134 corresponding to the first image 126. The receiving device 104 may be a smartphone, tablet, or computer wirelessly connected to the wearable device 102. In one example, the receiving device 104 may be a server or other suitable database accessible via the cloud or the internet. In one example, the first image 126 is transmitted using a wireless connection established between the communication module 108 of the wearable device 102 and the communication module 128 of the receiving device 104 using a wireless protocol selected from: a Bluetooth protocol, a Bluetooth Low-Energy (BLE) protocol, a ZigBee protocol, Near-Field Magnetic Induction (NFMI), Near-Field Electromagnetic Induction (NFEMI), a Wi-Fi (IEEE 802.11) protocol, a radio frequency (RF) protocol, an ultra wide band protocol or any other protocol for establishing a wireless connection between wearable device 102 and the receiving device 104, or the wearable device 102 may connect with the receiving device 104 using 3G, 4G, or 5G mobile wireless telecommunications technology.

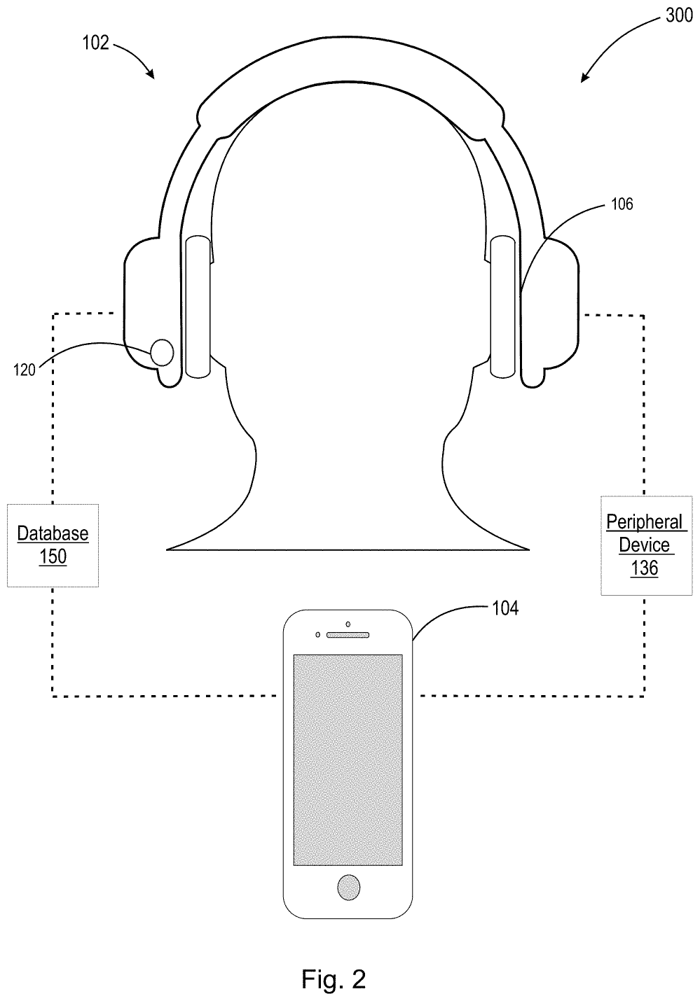

FIG. 2 is a schematic illustration of audio system 200 according to the present disclosure. System 200 includes a wearable device 102, a receiving device 104, and a peripheral device 136 discussed below. The wearable device 102 may include a first sensor 118 and a second sensor 120, and the peripheral device 136 may also include the first sensor 118, the second sensor 120, or a peripheral sensor 138, or any combinations thereof. As an example, the peripheral device 136 may include the first sensor 118, and the wearable device 102 may include the second sensor 120.

Wearable device 102 includes first speaker 106 and communication module 108 (shown in FIG. 3). First speaker 106 (shown in FIG. 3) is arranged to produce a first audio signal proximate at least one ear of a user in response to audio data sent and/or received from communication module 108. Communication module 108 is arranged to send and/or receive data from an antenna, e.g., antenna 110 as shown in FIG. 3. The data sent or received can be, for example, audio data or communication data sent and/or received from at least one of a plurality of external devices (e.g., receiving device 104), data sent and/or received regarding a trigger event (discussed below), and data sent and/or received comprising first image data 134 (discussed below). It should be appreciated that communication module 108 can be operatively connected to processor 112 (shown in FIG. 3) and memory 114 (shown in FIG. 3). The processor 112 is arranged to detect a trigger event and instruct a first sensor 118 to capture a first image 126 or transmit the first image 126 to a receiving device 104. Memory 114 is arranged to store the first image 126 and instructions for the detection of a trigger event 150. The processor 112 and the memory 114 are operatively arranged to execute and store, respectively, a first set of non-transitory computer-readable instructions 116 (shown in FIG. 3). It should also be appreciated that, although not illustrated, wearable device 102 may include a battery or other power source capable of providing electrical power to the various electronic components discussed above.

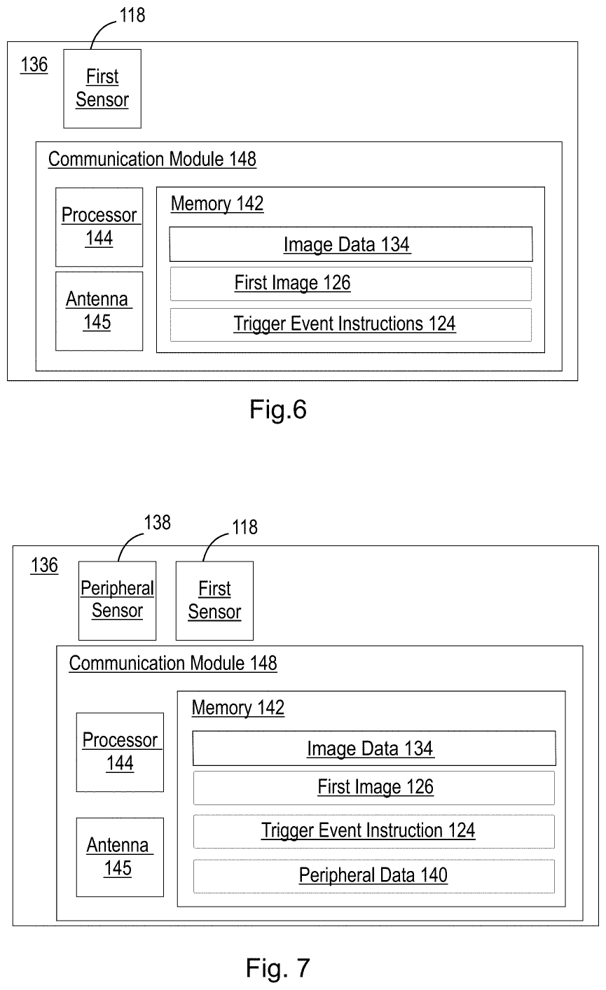

In an aspect, the wearable device 102 includes the second sensor 120 arranged on or within wearable device 102. Second sensor 120 is arranged to capture data 122 corresponding with detection of a trigger event. It should be appreciated that first sensor 118 and/or the second sensor 120 may each comprise multiple sensors which together capture the first image 126 and first image data 134 and/or the second sensor data 122 which provides indication of a trigger event. The peripheral device 136 comprises the first sensor 118. First sensor 118 is arranged to capture a first image 126, where the first image 126 can be captured as part of an augmented reality experience or can include an image generated from data from a LIDAR sensor, radar sensor, thermal sensor, or ultrasonic sensor. First sensor 118 can be selected from: a LIDAR sensor, a radar sensor, a thermal sensor, an ultrasonic sensor, and/or a camera. The peripheral device 136 can be any device having a memory 142, processor 144, and communication module 148 (shown in FIG. 6) capable of wireless communication with the wearable device 102. The peripheral device 136 may be any type of device capable of establishing a wireless or wired data connection with the wearable device 102. In some aspects, the peripheral device 136 is configured to be worn or attached to a portion of the user's body, for example, the user's neck. In some aspects, the peripheral device 136 is arranged apart from the user's body, for example, a computer arranged in an environment in which the user is located. The peripheral device 136 may include a cell phone, fitness tracker, smart watch, headphones, portable computing device, or any type of device that the wearable device may be. In some aspects, the peripheral device 136 may include first sensor 118, for example, a camera, where the field of view of the camera is controllable. In some aspects, the processor 144 of the peripheral device 136 may utilize sensor data 122 from the second sensor 120, for example, the second sensor 120 arranged on the wearable device 102, to determine the field of view of the first sensor 118 on the peripheral device 118.

During operation of the wearable device 102, the second sensor 120 arranged on or in the wearable device 102 may collect motion data 122 corresponding to a relative motion between a user and the wearable device 102 or the relative motion of the wearable device 102 in the environment. The processor 112 of the wearable device 102 can then detect a trigger event based on the data 122 collected by the second sensor 120. The wearable device 102 can then instruct the peripheral device 136, using the communication module 108 of the wearable device 102 and the communication module 148 of the peripheral device 136 to the first sensor 118 to capture an image 126. Alternatively, when the processor 112 of the wearable device 102 detects a trigger event based on the data collected by the second sensor 120, the communication module 108 of the wearable device 102 can send trigger event instructions 124 to the communication module 148 of the peripheral device 136 to transmit the first image 126. The processor 144 of the peripheral device 136 can initiate transmission of the first image 126 from the peripheral device 136 to a receiving device 104 using the communication module 148 of the peripheral device 136 and a communication module 128 of the receiving device 104. The first sensor 118 may have already captured the first image 126 before the second sensor 120 and processor 112 detect the trigger event, the first sensor 118 may capture the first image 126 after the second sensor 120 and processor 112 detect the trigger event, or the first sensor 118 may capture the first image 126 after being triggered by the processor 112 after the processor 112 detects the trigger event based on the data 122 collected by the second sensor 120. As an example, if the first image 126 is not transmitted to the receiving device 104, or before the first image 126 is transmitted to the receiving device 104, the first image 126 may be stored on the memory 142 of the peripheral device 136.

The receiving device 104 may be any device having a memory 130, processor 132, antenna 133, and communication module 128 (shown in FIG. 4), arranged to send and/or receive data, and receive image data 134 corresponding to the first image 126. The receiving device 104 may be a smartphone, tablet, or computer wirelessly connected to the wearable device 102. In one example, the receiving device 104 may be a server or other suitable database accessible via the cloud or the internet. In one example, the first image 126 is transmitted using a wireless connection established between the communication module 108 of the wearable device 102 and the communication module 128 of the receiving device 104 using a wireless protocol selected from: a Bluetooth protocol, a Bluetooth Low-Energy (BLE) protocol, a ZigBee protocol, Near-Field Magnetic Induction (NFMI), Near-Field Electromagnetic Induction (NFEMI), a Wi-Fi (IEEE 802.11) protocol, a radio frequency (RF) protocol, an ultra wide band protocol or any other protocol for establishing a wireless connection between wearable device 102 and the receiving device 104, or the wearable device 102 may connect with the receiving device 104 using 3G, 4G, or 5G mobile wireless telecommunications technology.

In another aspect, system 200 includes a wearable device 102, a receiving device 104, and a peripheral device 136 discussed below. The wearable device 102 may include a first sensor 118 and a second sensor 120. The peripheral device 136 may also include the first sensor 118, the second sensor 120, or a peripheral sensor 138, or any combinations thereof. As an example, the peripheral device 136 includes a first sensor 118 and a peripheral sensor 138, and the wearable device 102 includes a second sensor 120.

The peripheral device 136 includes peripheral sensor 138 that is arranged to obtain peripheral data 140 which can be used in conjunction with the data 122 obtained by the second sensor 120 to detect a trigger event. The peripheral device 136 can be any device having a memory 142, processor 144, and communication module 148 (shown in FIG. 7) capable of wireless communication with the wearable device 102. The peripheral device 136 may be any type of device capable of establishing a wireless or wired data connection with the wearable device 102. In some aspects, the peripheral device 136 is configured to be worn or attached to a portion of the user's body, for example, the user's neck. In some aspects, the peripheral device 136 is arranged apart from the user's body, for example, a computer arranged in an environment in which the user is located. The peripheral device 136 may include a cell phone, fitness tracker, smart watch, headphones, portable computing device, or any type of device that the wearable device may be. In some aspects, the peripheral device 136 may include first sensor 118 and/or peripheral sensor 136, for example, a camera, where the field of view of the sensor 118/136 is controllable. In some aspects, the processor 144 of the peripheral device 136 may utilize sensor data 122 from the second sensor 120, for example, the second sensor 120 arranged on the wearable device 102, to determine the field of view of the first sensor 118 and/or peripheral sensor 136. In some aspects, data from both the second sensor 120 and the peripheral sensor 138 is used to detect a trigger event. As an example, the second sensor 120 could be a microphone which is turned from low power mode to high power mode to detect a voice command to capture the first image 126 once a peripheral sensor 138 on a peripheral device 140, for example, a camera facing the user, detect that the user's jaw is moving. In some aspects, the peripheral sensor 138 could be directed towards the user's face upon detection of sound during operation in a low power mode.

During operation of the wearable device 102, the second sensor 120 arranged on or in the wearable device 102 may collect motion data 122 corresponding to a relative motion between a user and the wearable device 102 or the relative motion of the wearable device 102 in the environment. The wearable device 102 may collect additional data 140 regarding the trigger event using the peripheral sensor 138. The processor 112 of the wearable device 102 can then detect a trigger event based on the data 122 collected by the second sensor 120 and peripheral sensor 138.

The wearable device 102 can then instruct the peripheral device 136, using the communication module 108 of the wearable device 102 and the communication module 148 of the peripheral device 136, to capture the first image 126 using the first sensor 118. Alternatively, when the processor 112 of the wearable device 102 detects a trigger event based on the data 122/140 collected by the second sensor 120 and peripheral sensor 136, the communication module 148 of the wearable device 102 can send trigger event instructions 124 to the communication module 148 of the peripheral device 136 to transmit the first image 126. The processor 144 of the peripheral device 136 can initiate transmission of the first image 126 from the peripheral device 136 to a receiving device 104 using the communication module 148 of the peripheral device 136 and a communication module 128 of the receiving device 104. The first sensor 118 may have already captured the first image 126 before the trigger event was detected, the first sensor 118 may capture the first image 126 after the trigger event is detected, or the first sensor 118 may capture the first image 126 after being triggered by the processor 112 after the processor 112 detects the trigger event based on the data 122 collected by the second sensor 120 and the peripheral sensor 138. As an example, if the first image 126 is not transmitted to the receiving device 104, or before the first image 126 is transmitted to the receiving device 104, the first image 126 may be stored on the memory 142 of the peripheral device 136.

In an example, the second sensor 120 may be configured to detect a position or orientation and/or change in position or orientation of the wearable device 102 or user. The second sensor 120 may comprise an orientation tracking system which can include a head-tracking or body-tracking system for detecting a direction in which the user is facing, as well as movement of the user and the wearable device 102. The second sensor 120 may comprise an optical-based tracking system, accelerometer, magnetometer, gyroscope, or radar. For example, the second sensor 120 may be an inertial mass unit (“IMU”), such as, a single IMU having three-dimensional (3D) accelerometers, gyroscopes and/or magnetometers. As an example, second sensor 102 may collect motion data regarding a trigger event, which may be detection that wearable device 102 has come to a rest after a minimum duration of motion.

In an example, the second sensor 120 may be configured to detect eye movement, for example, movement of a user's eyes back and forth or up and down, the direction of a user's gaze, that a user's gaze is fixated in a particular direction or orientation, movement of a user's eye or the muscles on a user's face, such as blinking or an eye brow raise, and/or pupil dilation. The second sensor 120 may comprise an eye movement sensor comprising one or more cameras fixed on a user's eyes. The cameras may be arranged on or in the wearable device 102 or a peripheral device 136. The eye movement sensor may comprise electrodes which contact the skin and measure electrical impulses. As an example, pupil dilation may reflect concentration or arousal, or the combination of gaze fixation and pupil dilation may be indicative of the user concentrating on something. As an example, the second sensor 120 may detect motion data 122 indicating that a user's gaze is fixated in a particular direction or orientation, which can be detected, for example, when the user's head comes to a rest and then the user's eyes comes to a rest.

In aspects, the wearable device 102 or peripheral device 136 include hardware and circuitry including processor(s)/processing system and memory configured to implement determining an electromyogram (EMG) based on signals collected from electrodes positioned on the wearable device 102. In an example, an EMG may be determined based on signals collected from one or more electrodes positioned over the frontal belly of occipitofrontalis, over the corrugator supercilii, over the procerus, over the right temporalis, and/or over the left temporalis. The EMG may be used to determine a frequency and/or duration of eye blinking associated with the subject

In aspects, the wearable device 102 or peripheral device 136 include hardware and circuitry including processor(s)/processing system and memory configured to implement determining an electrooculogram (EOG) based on: signals collected from an electrode positioned over the left temporalis, the right temporalis, and a third electrode, determining pupil eye movement associated with the subject based on the EOG. Pupil movement determined from an EOG refers to at least one of the pupil moving from the left side of the subject's eye to the right side of the subject's side or the pupil moving from the right side of the subject's eye to the left side of the subject's eye.

In an example, the second sensor 120 may be configured to detect location, for example, recognize a specific location or recognize a change in location. The second sensor 120 may comprise location based-detection systems such as a global positioning system (GPS) location system, a Wi-Fi location system, an infra-red (IR) location system, a Bluetooth beacon system, etc. The location based-detection systems can be configured to detect changes in the physical location of the wearable device 102 and/or user and provide updated location data 122 to the location-based audio engine in order to indicate a change in the location of user.

Location based-detection systems can also be configured to detect the orientation of the user, e.g., a direction of the user's head, or a change in the user's orientation such as a turning of the torso or an about-face movement. In some examples, this position tracking system can detect that user has moved proximate a location, or that the user is looking in the direction of a location. In particular example implementations, the Location based-detection system can utilize one or more location systems and/or orientation systems to determine the location and/or orientation of the user, e.g., relying upon a GPS location system for general location information and an IR location system for more precise location information, while utilizing a head or body-tracking system to detect a direction of the user's viewpoint.

In an example, the second sensor 120 may be configured to detect hand gestures, for example, recognize a hand gesture where the user touches the device (for example a swipe (e.g., movement across a touch capacitive sensor), a single-tap, a double-tap (tapping at least two times over a predetermined period of time), triple-tap (tapping at least three times over a predetermined period of time) or any other rhythmic cadence/interaction with touch capacitive sensor etc.), a hand wave, a thumbs up, or a finger pinch. The second sensor 120 may comprise, for example, a capacitive touch sensor, a camera, a motion sensor, or an electrical sensor. The second sensor 120 may detect electrical measurements of muscle motion to detect that a user is making a hand gesture such as a finger pinch. The second sensor 120 may utilize one or more cameras, which may be positioned at different locations, for example, on the wearable device 102 or on the peripheral device 136, to detect a hand gesture such as a hand wave. The second sensor 120 may be arranged apart from the wearable device 102 or on a peripheral device 136 other than the wearable device 102. As an example, a second sensor 120 to detect hand gestures may be arranged on a peripheral device 136, such as a wrist worn device like a smart watch or fitness tracker, and may detect motion of the wrist and hand. As another example, one or more second sensors 120 may work in combination with other sensors to detect a hand gesture. For example, a peripheral device 136, such as the wrist worn device, may detect movement of the hand and wake up a camera of the wearable device 102 or even another device which detects the hand gesture, such as a hand wave or a finger pinch.

In an example, the second sensor 120 may be configured to detect speech or voice utterances from a user. The second sensor 120 may comprise one or more audio sensors, for example, microphones. As an example, sound data 122 that is captured by the second sensor 120 may be sent to and received by a processor which compares the sound data 122 with data in a database of voice commands 150 that contains information about which sound data 122 triggers capture and/or transmission of the first image 126. The database of voice commands 150 may be embedded on the wearable device 102, located on a peripheral device 136 connected to the wearable device 102, or located in the cloud. In an example, the audio sensors may be continuously or periodically turned on or in an active state to detect speech or voice utterances. As another example, the audio sensors may be turned on or switched from a standby state to an active state by a triggering event detected by one or more additional sensors, for example, peripheral sensor 138 arranged on peripheral device 136. For example, a camera or other visual sensor or a motion sensor arranged on, for example, a peripheral device 136 or the wearable device 102, may detect that a user's jaw is moving, which triggers the audio sensor to be turned on or to the active state.

In an example, the second sensor 120 may be configured to capture a low-resolution image. The second sensor 120 may be a camera that has low resolution or is operating in a lower-power or lower resolution state. As another example, the low resolution camera may be a second, low resolution camera on the wearable device 102 or a peripheral sensor 138 on a peripheral device 136. Alternatively, the low-resolution image may be captured by a first sensor 118 that can operate in a lower-resolution state during which it captures the low-resolution image. In an aspect, during operation in a higher-resolution state, the first sensor 118 is arranged to capture higher resolution images, such as the first image 126. Image data from the low-resolution image is transmitted to a processor which uses image processing techniques to detect a trigger event. In an aspect, after detection of the trigger event, the first sensor 118 captures the first image 126, a higher-resolution image. In an aspect, after detection of the trigger event, the processor 112 of the wearable device 102, or the processor of any device on which the first sensor 118 is arranged, for example the processor 144 of the peripheral device 136, triggers the transmission of the first image 124 to the receiving device 104. In an aspect, the trigger event is the detection of an object in the low-resolution image. The object may be an object from the environment, for example, a tree or a building, identification of a specific object, for example, a specific building, or identification of a particular image, such as a thumbs up hand gesture. In an aspect, the trigger event may be the detection of a motion artifact in the low-resolution image. In an aspect, motion artifacts are characteristics of the image which indicate that an image was taken using a low resolution camera, for example, a camera using a low frame rate or low exposure time, and can include tearing of the image or directional blurring of the image. As an example, directional blurring can be distinguishable from an out of focus image by parts of the image being blurred and the blurring following a particular direction, in contrast with blurring resulting from poor focus. In an aspect, camera settings, such as frame rate, exposure, high or low resolution state, and high or low power state, are optimized for power consumption based on detection of trigger events, for example, a combination of detection of the position and/or orientation of a user and detection of motion artifacts in a captured image.

In an aspect, the second sensor and/or peripheral sensor may comprise multiple sensors and comprise multiple types of sensors. In an aspect, the processor 112 of the wearable device 102, or the peripheral device 136 on which the first sensor 118 is located, may be arranged to detect multiple trigger events before initiating capture of the first image 126 or initiating transmission of the first image 126. For example, the first image 126 may be captured or transmitted after detection of the position or orientation of the user and a specific location or location change. As another example, the first image 126 may be captured or transmitted after detection of the position or orientation of the user and objects or motion artifacts in a low-resolution image. As another example, the first image 126 may be captured or transmitted after detection of the position or orientation of the user and human voice utterances. As another example, the first image 126 may be captured or transmitted after detection of the position or orientation of the user and eye movements or hand gestures of the user.

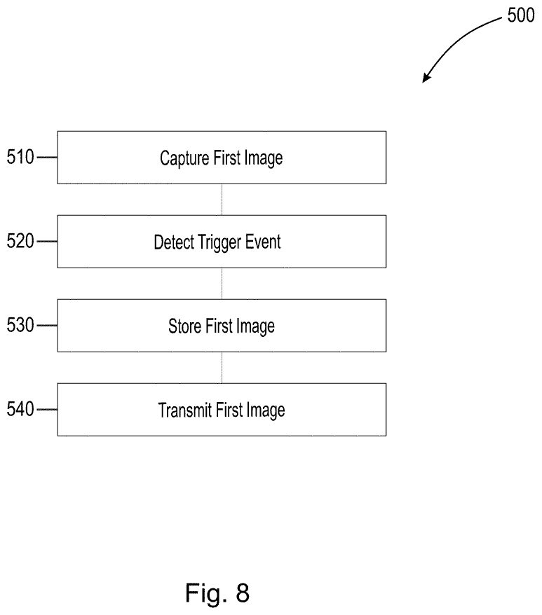

FIG. 8 is a flow-chart illustrating the steps of a method of controlling an audio system according to the present disclosure. The method 500 includes the steps of: capturing a first image using a first sensor (step 510); detecting a trigger event using the second sensor 120 configured to collect motion data 122, the motion data 122 corresponding to a relative motion between a user and the wearable device 102, the relative motion of the wearable device 102 in an environment, or motion of a body part of a user, and a processor 112 of the wearable device 102, the processor 112 configured to detect a trigger event based on the motion data 122 collected by the second sensor 120 (step 520); storing the first image 126 on a memory 114 of the wearable device 102 (step 530); and transmitting the first image 126 to a receiving device 104 using a communication module 108 of the wearable device 102, the communication module 108 arranged to wirelessly transmit the first image 126 to the receiving device 104 (step 540).

Other implementations are within the scope of the following claims and other claims to which the applicant may be entitled.

While various examples have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the examples described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific examples described herein. It is, therefore, to be understood that the foregoing examples are presented by way of example only and that, within the scope of the appended claims and equivalents thereto, examples may be practiced otherwise than as specifically described and claimed. Examples of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

1. A wearable device comprising:
a first sensor configured to capture a first image;
a second sensor configured to collect motion data, the motion data corresponding to a relative motion between a user and the wearable device, the relative motion of the wearable device in an environment, or a motion of a body part of the user;
a communication module configured to wirelessly transmit the first image to a receiving device; and
a processor configured to detect a trigger event based on the motion data collected by the second sensor, the processor further configured to initiate capture of the first image by the first sensor upon detection of the trigger event.

2. The wearable device of claim 1, wherein the first sensor is a visual camera, thermal imaging sensor, or Light Detection and Ranging (LiDAR) sensor.

3. (canceled)

4. The wearable device of claim 1, wherein the second sensor is an eye movement sensor or a location sensor.

5. The wearable device of claim 1, wherein the trigger event corresponds with a detection that the wearable device has come to rest for a minimum duration after a period of motion.

6. The wearable device of claim 1, wherein the trigger event corresponds with a fixation of a gaze of the user in a first direction for a period of time.

7. The wearable device of claim 1, wherein the trigger event corresponds with recognition that the wearable device is in a first location or has changed location.

8. A system for selective image capture, comprising:
a first sensor configured to capture a first image; and
a wearable device, comprising:
a second sensor configured to collect motion data, the motion data corresponding to a relative motion between a user and the wearable device, the relative motion of the wearable device in an environment, or a motion of a body part of the user;
a communication module configured to wirelessly transmit the first image to a receiving device; and
a processor configured to detect a trigger event based on the motion data collected by the second sensor, the processor further configured to initiate capture of the first image by the first sensor upon detection of the trigger event.

9. The system of claim 8, wherein the first sensor is a visual camera, thermal imaging sensor, or Light Detection and Ranging (LiDAR) sensor.

10. The system of claim 8, wherein the first sensor is arranged on a peripheral device and a field of view of the first sensor is controllable by the wearable device.

11. The system of claim 8, wherein the second sensor is an inertial measurement unit (IMU) comprising one or more accelerometers, one or more gyroscopes, or one or more magnetometers.

12. The system of claim 8, wherein the second sensor is an eye movement sensor or a location sensor.

13. The system of claim 8, wherein the trigger event corresponds with a detection that the wearable device has come to rest for a minimum duration after a period of motion or the trigger event corresponds with a fixation of a gaze of the user in a particular direction for a period of time.

14. The system of claim 8, wherein the trigger event corresponds with a recognition that the wearable device is in a first location or has changed location.

15. A method for selective image capture, comprising:
detecting a trigger event using a second sensor configured to collect motion data, the motion data corresponding to a relative motion between a user and a wearable device, the relative motion of the wearable device in an environment, or a motion of a body part of the user, and a processor of the wearable device, the processor configured to detect a trigger event based on the motion data collected by the second sensor;
capturing a first image by a first sensor upon detection of the trigger event and
storing the first image on a memory of the wearable device.

16. The method of claim 15, wherein the first sensor is a visual camera, thermal imaging sensor, or Light Detection and Ranging (LiDAR) sensor.

17. The method of claim 15, wherein the second sensor is an inertial measurement unit (IMU) comprising one or more accelerometers, one or more gyroscopes, or one or more magnetometers.

18. The method of claim 15, wherein the second sensor is an eye movement sensor or a location sensor.

19. The method of claim 15, wherein the trigger event corresponds with a detection that the wearable device has come to rest for a minimum duration after a period of motion or the trigger event corresponds with a fixation of a gaze of the user in a particular direction for a period of time.

20. The method of claim 15, wherein the trigger event corresponds with recognition that the wearable device is in a first location or has changed location.

21. The wearable device of claim 1, wherein the wearable device is a set of headphones.
